(19) United States
(12) Patent Application Publication
(10) Pub. No.: US 2011/0061606 A1
(43) Pub. Date: Mar. 17, 2011

(54) RESTRAINING DEVICE

(75) Inventors: Mardig Sevadjian, Oakville (CA); Eda Arafat, Burington (CA); Nabil Arafat, Burlington (CA)

(73) Assignee: CARDON REHABILITATION & MEDICAL EQUIPMENT LTD., Burlington (CA)

(21) Appl. No.: 12/883,157

(22) Filed: Sep. 15, 2010

Related U.S. Application Data
(60) Provisional application No. 61/243,139, filed on Sep. 16, 2009.

(51) Int. Cl. A61D 3/00

(52) U.S. Cl. 119/756

(57) ABSTRACT

A restraining device having an upper actuator for mounting to a surface, such as a table, bed, chair, stool or bench is described. The upper actuator can be activated by a control means, such as one or any combination of a hand held device, hand switch, foot switch, or control panel, raising or lowering the upper actuator.

This application claims the benefit of U.S. Provisional application No. 61/243,139 filed Sep. 16, 2009 which incorporated herein by reference in its entirety.

### FIELD OF THE INVENTION

The invention relates generally to a restraining device and more particularly to a restraining device that is capable of restraining subjects of different sizes.

### BACKGROUND OF THE INVENTION

Restraining devices have applicability in many fields, and in particular, the health, animal grooming and veterinary fields. Current restraining devices may include manually operated bars that are mounted to a surface which accommodates a human or animal subject. Typically, the surface is a table or a bed and the manually operated bars are mounted at a first end of the surface. Ropes, leashes or other implements may be used to connect the subject to the manually operated bars, thereby restraining the subject to the surface.

What is needed is an improved restraining device that permits the device to be easily adapted to accommodate different sized subjects, as well as to accommodate different heights of the user, while maintaining a secure restraint and stable surface on which to restrain the subject.

### SUMMARY OF THE INVENTION

In accordance with one aspect of the invention, there is provided a restraining device that has an upper actuator for mounting to a surface, such as a table, bed, chair, stool or bench. The upper actuator is activated by a control means, such as one or any combination of a hand held device, hand switch, foot switch, or control panel, raising or lowering the upper actuator.

In an aspect of the present invention a second end of the upper actuator is adapted to receive a harnessing means. The harnessing means may be removable from the upper actuator, irremovable from the upper actuator, or be a part of the upper actuator. In a preferred embodiment of the present invention the harnessing means is a T-Bar.

Through use of the control means, the user may raise or lower the upper actuator to adapt to the subject being restrained.

In an embodiment the T-Bar is adapted to receive a harness such as a rope or a leash at one or more attachment points. The T-Bar may be coupled to a harness at the attachment points via attachment means such as hooks, or loops. However, it is understood that any attachment means may be used. The T-Bar is adapted so that the attachment means may be moved to different attachment points along the T-Bar so that different sizes and positions of the subject may be accommodated.

In an embodiment of the present invention the T-Bar contains a center attachment point. In a preferred embodiment of the present invention the T-Bar contains three attachment points, a first attachment point at a first end of the T-Bar, a second attachment point at a second end of the T-Bar, and a third attachment in between the first and second attachment points. The third attachment point at the center of the T-Bar may permit a subject to be turned around by the user switching the harnesses held by the first and second attachment points while the third attachment point holds the subject in place. This makes it possible for the users, such as animal groomers and veterinarians, to work on both sides of subject without having any structural interference.

In an embodiment of the present invention, the third attachment point may be welded to the T-Bar and may also be capable of swiveling.

It is understood that more than one upper actuator may be mounted to a surface.

In a further embodiment of the present invention, the restraining table is mounted on a surface and a lower actuator is provided. At one end, the lower actuator is adapted to be mounted to the surface, such as a table, bed, chair, stool or bench. The second end of the lower actuator may be attached to a base (e.g. of the table, bed, chair, stool or bench) or may rest directly on the ground.

The lower actuator is connected to a power supply and is activated by a control means, such as one or any combination of a hand held device, hand switch, foot switch, or control panel, raising or lowering the lower actuator and thus the surface, e.g. of a table, bed, chair, stool or bench.

In an embodiment of the present invention, stabilizing columns are used to further stabilize the surface. The stabilizing columns are adapted to be mounted to the surface at one end, and to a base or the ground at the other end. In an embodiment of the present invention, the stabilizing columns are telescopic and contain a shaft connecting to a tube via a linear bearing.

### DESCRIPTION OF THE DRAWINGS

In the drawings which illustrate by way of example only a preferred embodiment of the invention:

FIG. 1 is a perspective view of a restraining device according to an embodiment of the present invention;

FIG. 2 is a perspective view of a restraining device according to an embodiment of the present invention;

FIG. 3 is a side view of a restraining device according to an embodiment of the present invention showing a power supply and lower actuator;

FIG. 4 is a an exploded view of the restraining device shown in FIGS. 1 and 2;

FIG. 5 is a perspective view of a restraining device according to an embodiment of the present invention containing a drawer;

FIG. 6 is a perspective view of a restraining device according to a further embodiment of the present invention;

FIG. 7 is a perspective view of a restraining device according to an embodiment of the present invention showing a foot switch and a hand switch;

FIG. 8 is a perspective view of a restraining device according to an embodiment of the present invention showing a foot switch and a hand switch;

FIG. 9 is an example of a hand switch that may be used with a restraining device according to an embodiment of the present invention;

FIG. 10 is an example of a foot switch that may be used with a restraining device according to an embodiment of the present invention;

FIG. 11 is a perspective view of a restraining device according to an embodiment of the present invention showing two hand switches;

FIG. 12 is a perspective view of a restraining device according to an embodiment of the present invention showing two hand switches;

FIG. 13 is a perspective view of a restraining device according to an embodiment of the present invention showing two foot switches;

FIG. 14 is a perspective view of a restraining device according to an embodiment of the present invention showing one foot switch and a hand set;

FIG. 15 is a perspective view of a restraining device according to an embodiment of the present invention showing one foot switch and a hand set;

FIG. 16 is an example of a hand set that may be used with a restraining device according to an embodiment of the present invention;

FIG. 17 is a perspective view of a stabilizing column that may be used with a restraining device according to an embodiment of the present invention.

### DETAILED DESCRIPTION

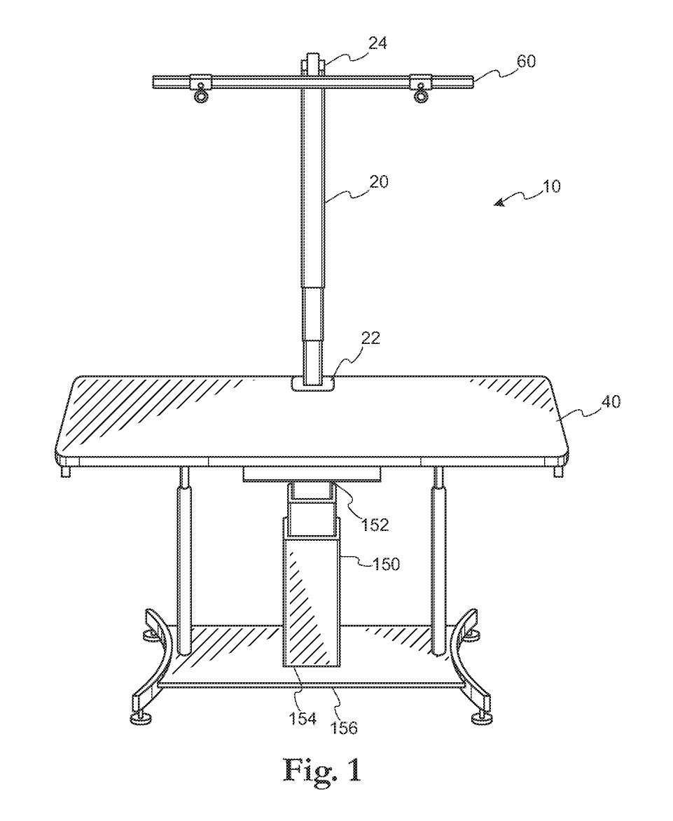

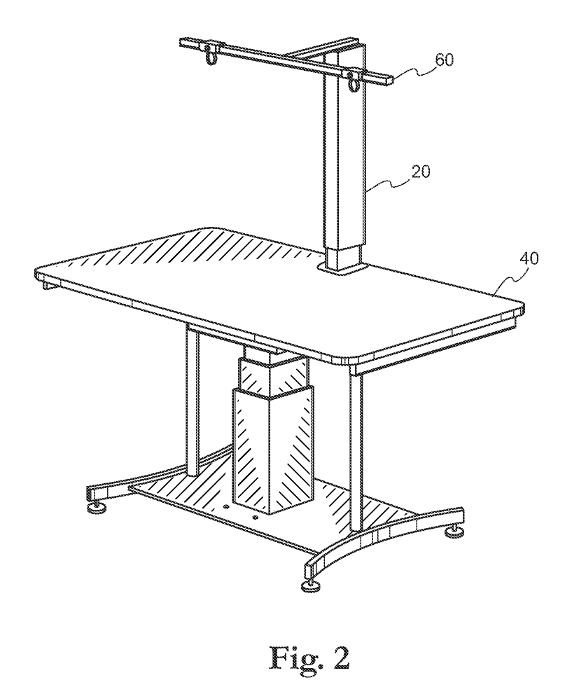

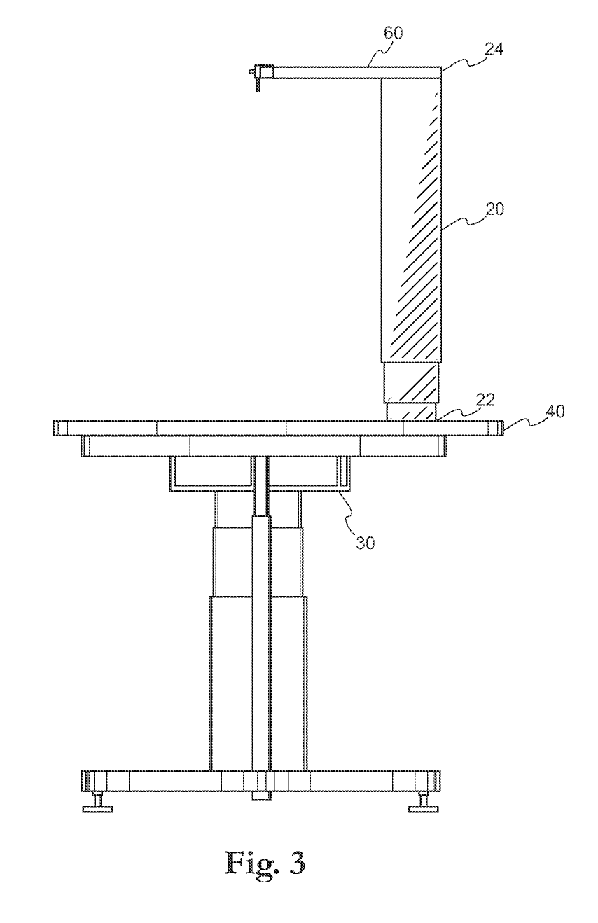

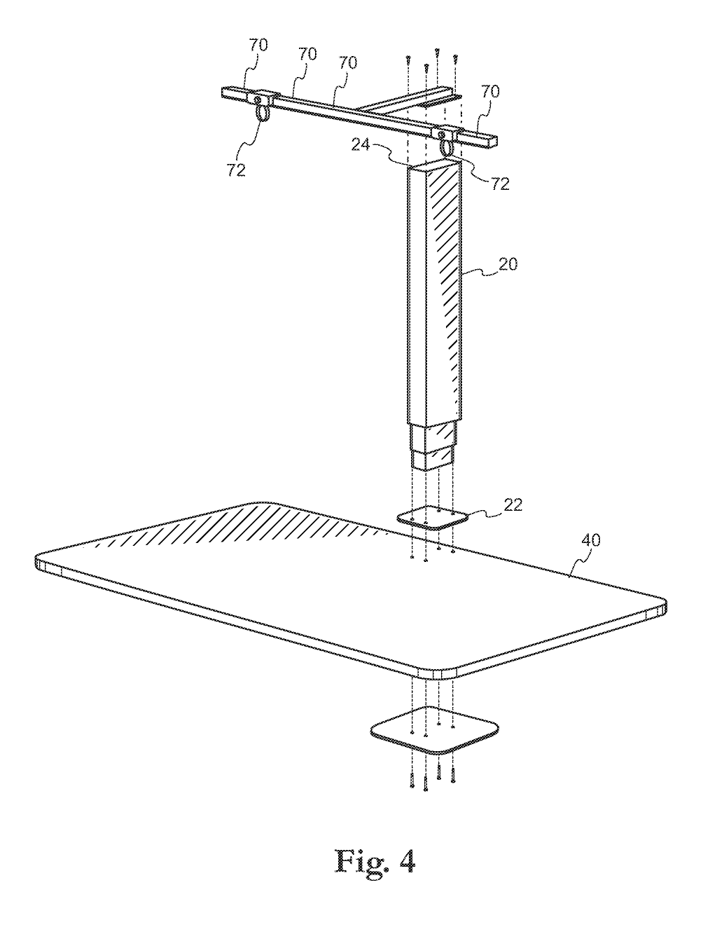

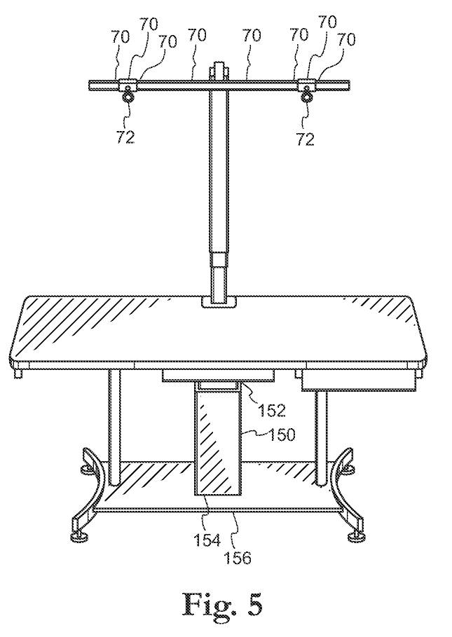

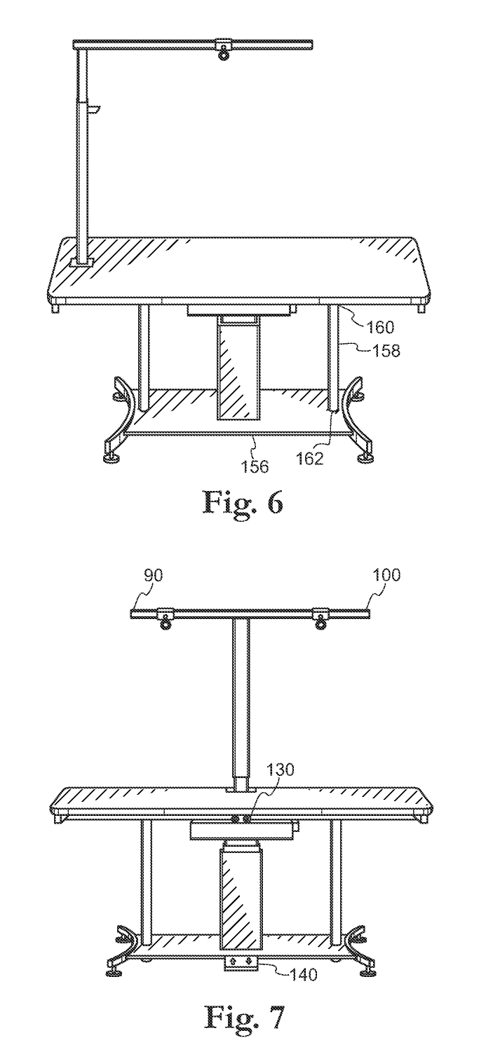

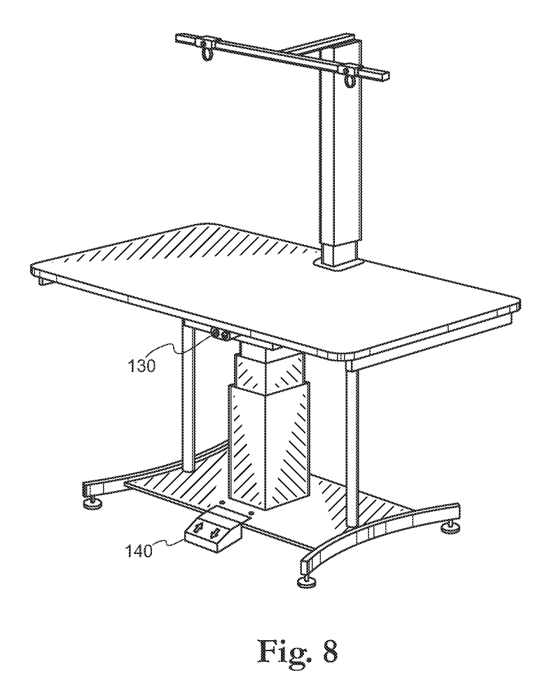

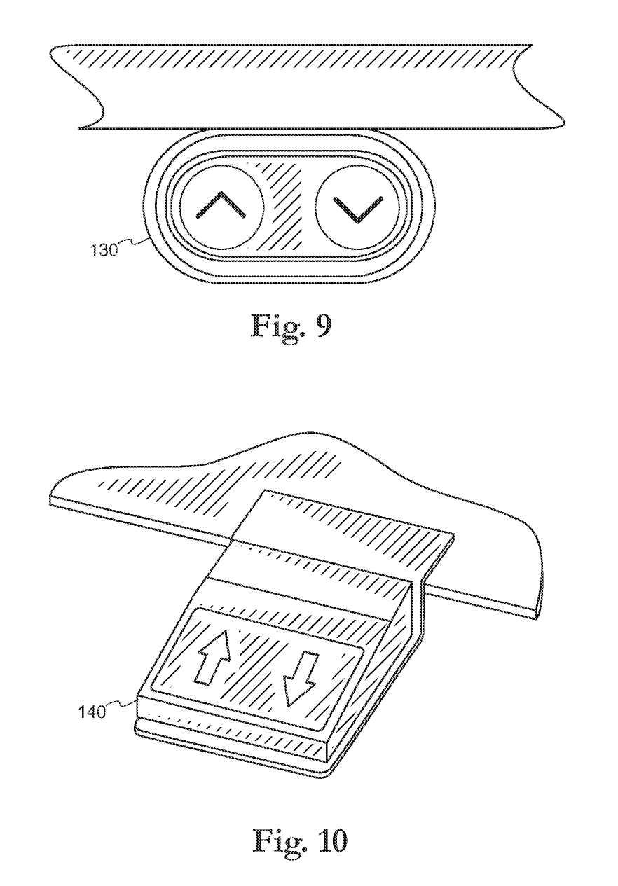

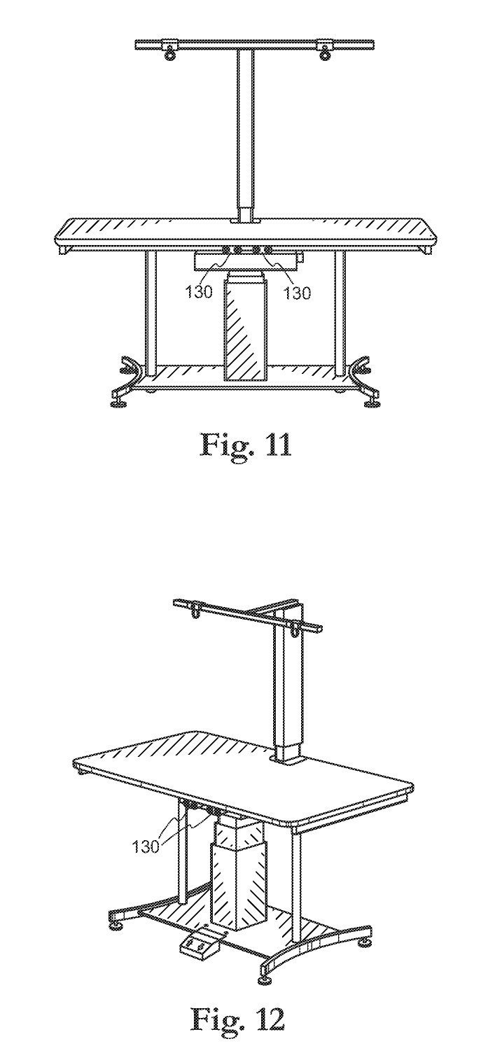

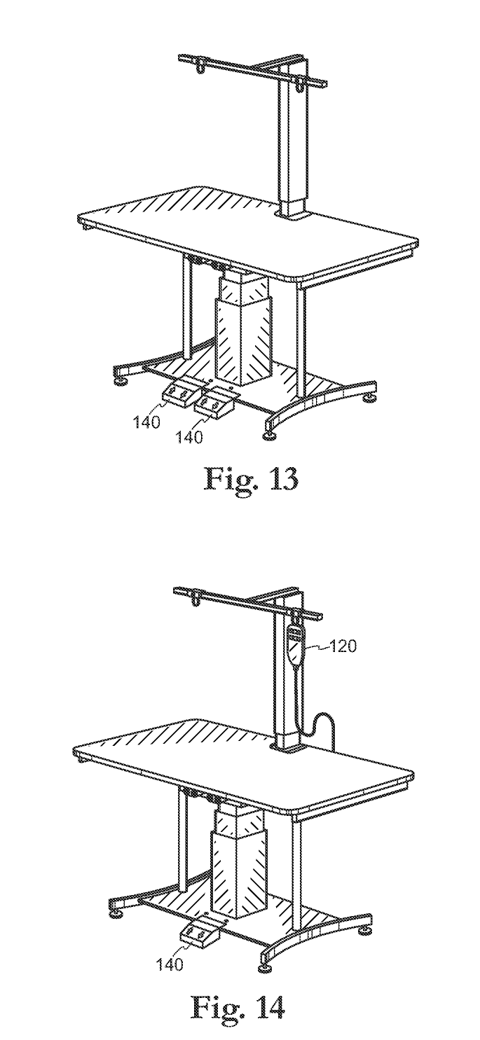

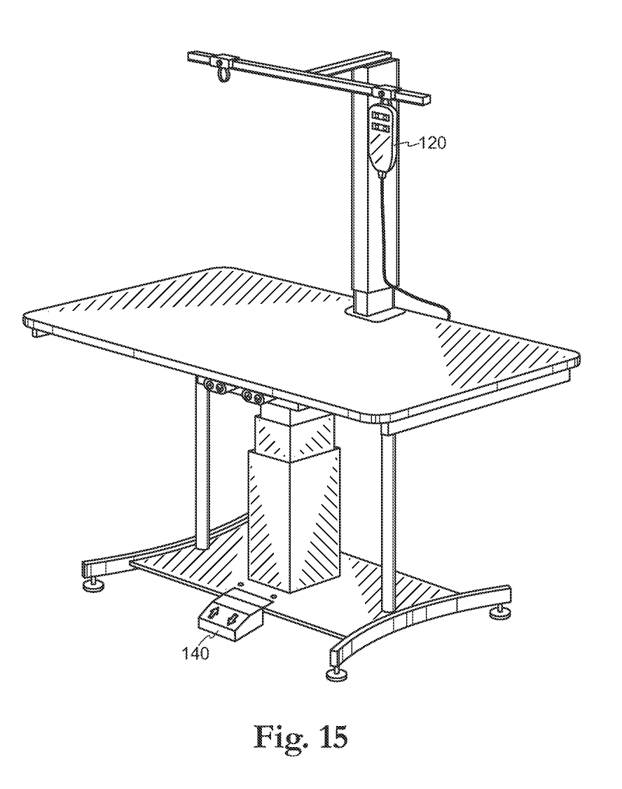

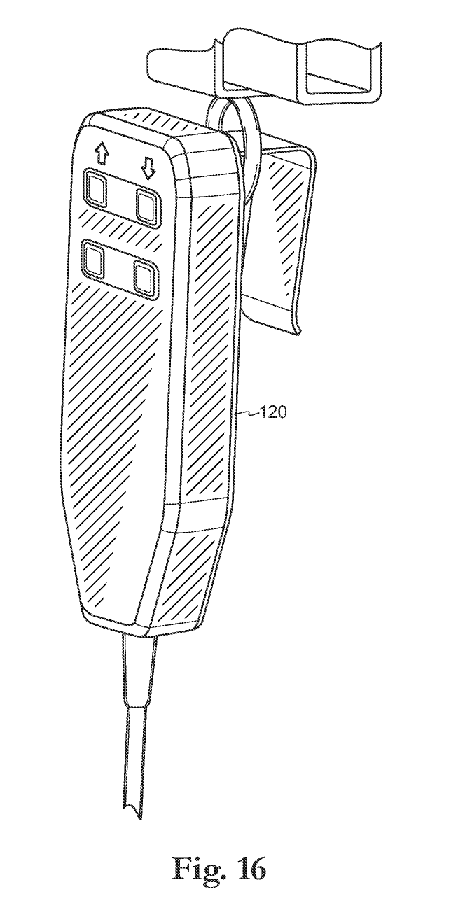

Referring to FIG. 1, a restraining apparatus according to an embodiment of the invention is shown generally at 10. Referring to FIGS. 1, 2 and 3, the apparatus includes an upper actuator 20 and a power supply 30. At one end 22, the upper actuator is adapted to be mounted to a surface, such as a table 40, a bed (not shown), chair (not shown), stool (not shown) or bench (not shown). The upper actuator is activated by a control means, such as one or any combination of a hand held device 120, hand switch 130, foot switch 140, or control panel (not shown), raising or lowering the upper actuator.

In an aspect of the present invention a second end of the upper actuator 24 is adapted to receive a harnessing means. In a preferred embodiment of the present invention the harnessing means is a T-Bar 60. It is understood that the harnessing means may be removable from the upper actuator, irremovable from the upper actuator, or be a part of the upper actuator.

Through use of the control means, the user may raise or lower the upper actuator to adapt to the subject being restrained.

In an embodiment the T-Bar 60 is adapted to receive a harness such as a rope or a leash at one or more attachment points 70. The T-Bar may be coupled to a harness at the attachment points via attachment means such as hooks, or loops 72. However, it is understood that any attachment means may be used. The T-Bar is adapted so that the attachment means may be moved to different attachment points along the T-Bar so that different sizes and positions of the subject may be accommodated.

In an embodiment of the present invention the T-Bar 60 contains a center attachment point. In a preferred embodiment of the present invention the T-Bar contains three attachment points, a first attachment point at a first end of the T-Bar 90, a second attachment point at a second end of the T-Bar 100, and a third attachment in between the first and second attachment points. The third attachment point at the center of the T-Bar may permit a subject to be turned around by the user switching the harnesses held by the first and second attachment points while the third attachment point holds the subject in place. This makes it possible for the users, such as animal groomers and veterinarians, to work on both sides of subject without having any structural interference.

In an embodiment of the present invention, the third attachment point may be welded to the T-Bar and may also be capable of swiveling.

It is understood that more than one upper actuator may be mounted to a surface.

In a further embodiment of the present invention, the restraining table is mounted on a surface and a lower actuator 150 is provided. At one end 152, the lower actuator is adapted to be mounted to a surface, such as a table 40, a bed (not shown), chair (not shown), stool (not shown) or bench (not shown). The second end 154 of the lower actuator may be attached to a base 156 (e.g. of the table, bed, chair, stool or bench) or may rest directly on the ground.

The lower actuator is connected to a power supply and is activated by a control means, such as one or any combination of a hand held device 120, hand switch 130, foot switch 140, or control panel (not shown), raising or lowering the lower actuator and thus the surface, e.g. of a table 40, bed, chair, stool or bench.

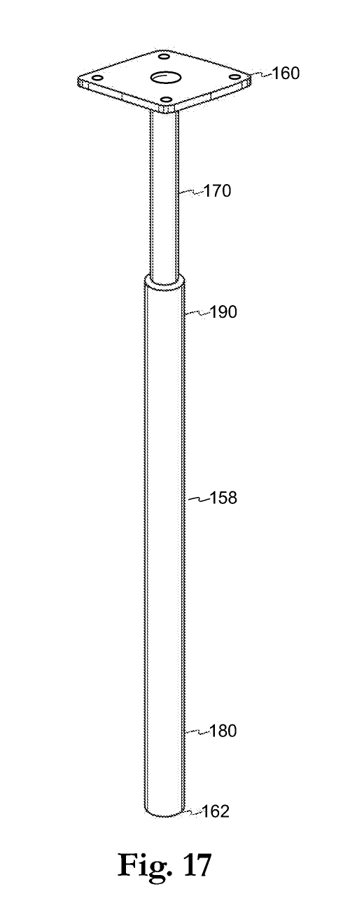

In an embodiment of the present invention, stabilizing columns are used to further stabilize the surface, as seen in FIG. 17. The stabilizing columns 158 are adapted to be mounted to the surface at one end 160, and to a base 156 or the ground at the other end. In an embodiment of the present invention, the stabilizing columns 158 are telescopic and contain a shaft 170 connect to a tube 180 via a linear bearing 190.

Various embodiments of the present invention having been thus described in detail by way of example, it will be apparent to those skilled in the art that variations and modifications may be made without departing from the invention. The invention includes all such variations and modifications as fall within the scope of the appended claims.

In one example preferred embodiment, a restraining device comprises a upper actuator adapted at a first upper actuator end to be mounted to a surface with a top face and a bottom face and with a harnessing means at a second upper actuator end, the upper actuator is capable of movement such that the harnessing means moves towards and away from the top face of the surface. Preferably, the harnessing means is a T-Bar adapted to receive one or more harnesses. Also, preferably, the control means are provided to move the upper actuator.

The example preferred embodiment may preferably further comprise a lower actuator adapted at a first lower actuator end to be mounted to the bottom face of the surface, the lower actuator capable of moving the surface towards and away from the second lower actuator end, and more preferably, the control means are provided to move the lower actuator. Also, the example preferred embodiment may preferably further comprise one or more stabilizing columns mounted to the bottom face of the surface.

What is claimed is:

1. A restraining device comprising a upper actuator adapted at a first upper actuator end to be mounted to a surface with a top face and a bottom face and with a harnessing means at a second upper actuator end, the upper actuator is capable of movement such that the harnessing means moves towards and away from the top face of the surface.

2. The restraining device of claim 1, wherein the harnessing means is a T-Bar adapted to receive one or more harnesses.

3. The restraining device of claim 1, wherein control means are provided to move the upper actuator.

4. The restraining device of claim 2, wherein control means are provided to move the upper actuator.

5. The restraining device of claim 1, comprising a lower actuator adapted at a first lower actuator end to be mounted to the bottom face of the surface, the lower actuator capable of moving the surface towards and away from the second lower actuator end.

6. The restraining device of claim 2, comprising a lower actuator adapted at a first lower actuator end to be mounted to the bottom face of the surface, the lower actuator capable of moving the surface towards and away from the second lower actuator end.

7. The restraining device of claim 3, comprising a lower actuator adapted at a first lower actuator end to be mounted to the bottom face of the surface, the lower actuator capable of moving the surface towards and away from the second lower actuator end.

8. The restraining device of claim 4, comprising a lower actuator adapted at a first lower actuator end to be mounted to the bottom face of the surface, the lower actuator capable of moving the surface towards and away from the second lower actuator end.

9. The restraining device of claim 5, wherein control means are provided to move the lower actuator.

10. The restraining device of claim 6, wherein control means are provided to move the lower actuator.

11. The restraining device of claim 7, wherein control means are provided to move the lower actuator.

12. The restraining device of claim 8, wherein control means are provided to move the lower actuator.

13. The restraining device of claim 1, comprising one or more stabilizing columns mounted to the bottom face of the surface.

14. The restraining device of claim 2, comprising one or more stabilizing columns mounted to the bottom face of the surface.

15. The restraining device of claim 3, comprising one or more stabilizing columns mounted to the bottom face of the surface.

16. The restraining device of claim 4, comprising one or more stabilizing columns mounted to the bottom face of the surface.

17. The restraining device of claim 5, comprising one or more stabilizing columns mounted to the bottom face of the surface.

18. The restraining device of claim 6, comprising one or more stabilizing columns mounted to the bottom face of the surface.

19. The restraining device of claim 7, comprising one or more stabilizing columns mounted to the bottom face of the surface.

20. The restraining device of claim 8, comprising one or more stabilizing columns mounted to the bottom face of the surface.

21. The restraining device of claim 9, comprising one or more stabilizing columns mounted to the bottom face of the surface.

22. The restraining device of claim 10, comprising one or more stabilizing columns mounted to the bottom face of the surface.

23. The restraining device of claim 11, comprising one or more stabilizing columns mounted to the bottom face of the surface.

24. The restraining device of claim 12, comprising one or more stabilizing columns mounted to the bottom face of the surface.
